(19) United States
(12) Patent Application Publication
(10) Pub. No.: US 2026/0249541 A1
(43) Pub. Date: Aug. 27, 2026

(54) Device for Producing Hollow Bodies

(71) Applicant: BEKUM Maschinenfabriken GmbH, Berlin (DE)

(72) Inventors: Ulrich Hennemann, Traismauer (AT); Michael Scharner, Traismauer (AT)

(21) Appl. No.: 19/116,013

(22) PCT Filed: Sep. 28, 2023
(86) PCT No.: PCT/EP2023/076829

§ 371 Date: Mar. 27, 2025

(30) Foreign Application Priority Data
Sep. 30, 2022 (EP) 22199070.8

(51) Int. Cl. B29C 49/56; B29C 49/04; B29L 31/00

(52) U.S. Cl. CPC B29C 49/5605; B29C 49/04; B29C 49/5603; B29L 2031/712

(57) ABSTRACT

Device for producing hollow bodies from thermoplastic plastic material in a blow molding process, comprising a cavity mold having at least two mold parts (2, 2a), wherein the mold parts (2, 2a) are movable relative to each other, a support device (6) on which at least one mold part (2) is displaceably mounted, and a first drive device (7) for displacing the at least one mold part on the support device (6) so that the two mold parts (2, 2a) approach or move apart in a displacement direction (18), wherein a second drive device (7) is configured to apply a closing force acting essentially in the displacement direction (18).

Device for producing hollow bodies from thermoplastic plastic material in a blow molding process, comprising a cavity mold having at least two mold parts, wherein the mold parts are movable relative to each other, a support device on which at least one mold part is displaceably mounted, and a first drive device for displacing the at least one mold part on the support device so that the two mold parts approach or move apart in a displacement direction.

Devices of the aforementioned type, also known as extrusion blow molding machines, are intended for producing a hollow plastic article by means of an extruded and head-formed tube, which is inflated under pressure between at least two closed mold parts or mold halves. Through subsequent cooling, demolding, and trimming of excess tube material, a finished plastic container is produced.

A crucial step in the manufacturing process is the opening and closing of the two mold parts that define the external contour of the article. The mold parts are generally mounted on so-called closing plates that permit a linear approach and retraction movement. Due to the internal pressure—typically about 10 bar—during the inflation of the plastic container in the mold, an appropriate counterpressure must be applied via a closing mechanism on the mold parts to prevent the mold from opening during the blow molding process. Moreover, the closing force typically clamps the beginning or the end of the tube. For demolding, the mold parts must be separated far enough (i.e. opened) so that the blown article can preferably be removed laterally between these mold parts. Therefore, the opening travel is generally dependent on the mold wall thickness or the article's diameter.

In order to reliably move the mold parts for opening and closing the device and to apply the necessary closing force to the two mold parts during the blow molding process, various solutions are known in the prior art.

From DE 1 814 883A1 , an extrusion blow molding machine is known in which a drive is provided for moving one mold half to apply the forces resulting from the blow pressure. The drive is effected by a hydraulic cylinder with a piston that is connected to a toggle lever. A central joint of the toggle lever is connected to a vertically acting piston of a horizontally shiftable cylinder. When closing the mold halves, the drive piston extends the toggle lever until it is fully extended, whereby the central joint of the toggle lever comes to rest on a stationary support. The pressure of the vertically acting piston holds the toggle lever in the extended position. Thus, when the mold is closed, the forces resulting from the blow pressure are transmitted via the piston and the extended toggle lever to a vertical beam of a frame of the device. To relieve the hydraulic piston-cylinder drive, it is provided that the pistons in the closed position of the cavity mold are lockable and that the locks transmit the forces resulting from the blow pressure directly onto a frame provided as a support device. However, a disadvantage is that both the displacement movement and the force application for the clamping pressure are effected by the same drive device.

From EP 1 598 165B1, a drive device for molds for producing containers-for example, bottles or similar articles from plastic materials-is known. The device includes a drive unit comprising a main drive and an auxiliary drive, whereby the main drive is electric and the auxiliary drive is mechanical. In this arrangement, the electric motor actuates two oscillating levers that connect half shells with two respective arms, at least one of which consists of an actuator cylinder. The two arms are pivotably connected on one side to a joint and on the other side to an oscillating lever. The drive device is, however, disadvantageously intended for swiveling a comparatively complex oscillating lever mechanism.

From WO 2018/216361A1, a mold-closing machine is further known that employs an electric servomotor to move a pair of movable plates—on which mold halves are mounted—into a closing direction by means of a ball screw. The mold-closing machine also comprises a hydraulic cylinder that is attached to one of the plates and pushes that plate in the closing direction. When the distance between the mold halves reaches a predetermined value, both the electric servomotor and the hydraulic cylinder are actuated. Thus, two different, parallel-acting drive devices are provided, which results in high energy consumption.

Object of the present invention is to alleviate or eliminate at least one of the disadvantages of the prior art. In particular, the object is to provide an energy-efficient device in which the employed drive devices are highly effective.

This is achieved by a device of the aforementioned type in which a second drive device is provided for applying a closing force acting essentially in the displacement direction. The inventive solution is based on the recognition that the requirements for the displacing movement of the mold parts, necessary to enable the removal of a plastic container produced by the blow molding process, and the requirements for applying the forces on the mold parts during the blow molding process are very different. On the one hand, it is advantageous that during the opening/closing movement the mold part is moved at a comparatively high speed in order to keep the cycle time short. On the other hand, the necessary closing force, which frequently exceeds 500 kN, must be applied to the mold parts during the blow molding process. Using a single drive device to meet these two differing requirements can only be achieved inefficiently. In known hydraulic closing systems, to date only a single hydraulic cylinder is used for both the closing movement and the generation of the closing force. To achieve the required closing pressure, particularly over 500 kN, a correspondingly large piston diameter is necessary. The resulting large cylinder cross-sections, however, lead to a high demand for hydraulic oil, increased energy consumption, and limited speed of the opening/closing movement. By employing the second drive device as proposed by the invention, which is designed to apply the closing force essentially in the displacement direction, two different drive devices can be selected, one for generating the displacement movement during the opening/closing movement and one for generating the closing force, so that each of the very different requirements can be met by a different, efficiently operating drive device. In principle, to transfer the mold parts between the open and closed positions, it is sufficient if only one mold part is displaceably mounted. Typically, the movement of the at least two mold parts is synchronized via a (known from prior art) synchronization device so that the mold parts are moved together during the opening/closing movement, approaching each other during closing and moving apart during opening.

Regarding a structurally simple configuration for moving the at least one mold part during the opening/closing movement, it is advantageous if a toggle lever with a first and a second lever element, connected via a joint, is provided for displacing the at least one mold part.

If the first drive device is arranged on a fixing element that is rigidly connected to the support device and on a pivotably mounted first lever element of the toggle lever, force can be transmitted from the first drive device via the toggle lever to the at least one mold part in a simple and efficient manner. Preferably, a piston of the first drive device engages the toggle lever so that when it extends, the toggle lever is stretched, thereby bringing the at least one mold part closer to the second mold part.

Advantageously, the first drive device is configured as a linear drive, particularly a hydraulic cylinder or an electric drive with a piston rod. Thus, the clamping movement can be efficiently effected by a hydraulic cylinder with a relatively small diameter or by an electric drive, such as an electromechanical cylinder (for example, a roller spindle with an electric drive). Alternatively, the electric drive may also be configured as a rotary drive with a gearbox and crank. In the case of an electric configuration, the braking energy can be fed back into an intermediate circuit, achieving further energy savings.

Preferably, the second drive device is configured as a linear drive, especially a hydraulic cylinder with a piston rod. The second drive device, which is provided for generating the closing force or applying a force stroke, comprises a significantly shorter stroke than the first drive device. However, since considerably higher forces (namely the closing forces for the two mold parts during the blow molding process) are applied via the second drive device, it is advantageous if the second drive device is more powerful than the first drive device.

If the second drive device is attached to the second lever element—preferably at a free protruding end of the second lever element, it is simply moved along with the movement of the second lever element initiated by the first drive device. Thus, the second drive device along with the at least one displaceably mounted mold part can be easily brought closer to the second mold part, so that in an end position of the first drive device only a comparatively short stroke, a so-called force stroke, is required by the second drive device to bring the at least one mold part into its closed position.

Advantageously, the at least one displaceably mounted mold part and the second drive device are mounted on a sliding element, which is displaceably mounted on the support device. For a simple and efficient displacing movement of the at least one mold part, mounting the mold part on a sliding element (for example, a carriage) is advantageous. The carriage is preferably supported at its base, with the mold part being attached via a closing plate to the upper, i.e. base-opposite), end of the carriage. The sliding element, which is preferably configured as a carriage, can be displaceably mounted in a linear guide, in particular on guide rail elements.

Advantageously, a hydraulic cylinder provided as the second drive device and/or its piston rod is equipped with diametrically opposed guide bearings for a connecting element between the hydraulic cylinder and/or the piston rod and the sliding element. With the aid of these guide bearings, the transverse forces generated by the closing movement of the toggle lever are absorbed. Thus, the piston rod/hydraulic cylinder experiences little or no transverse loading or bending stresses, which significantly reduces the wear on seals, etc.

If, in a closed position of the at least two mold parts, the toggle lever is arranged in a slightly overextended position—wherein the two lever elements in the overextended position preferably enclose an angle between 0.5° and 3°, particularly essentially 1°, the toggle lever can be secured in this position in a simple manner. Preferably, a stop is provided at which the toggle lever, particularly the first lever element, abuts in the closed position of the at least two mold parts. Thus, the toggle lever can be secured in the closed position of the at least two mold parts and, during the application of significant forces in the blow molding process, it is held in an essentially extended, that is, slightly overextended, position.

Advantageously, the second drive device is configured to displace the at least one mold half by up to 700 mm, preferably up to 500 mm. Consequently, the second drive device achieves only a displacement travel of a few hundred millimeters (e.g. between 200 mm and 400 mm), so that it can be designed for a comparatively short displacement travel and high force transmission. If the travel measures several hundred millimeters, it remains possible to use different mold thicknesses.

In contrast to the second drive device, the first drive device is designed to displace the displaceably mounted mold part further so that in the open position a lateral removal of the blown article is possible. Advantageously, the first drive device is therefore configured to displace the at least one mold half by between 0.7 m and 2 m. Furthermore, the first drive device is configured to perform a displacement path of the at least one mold half that essentially corresponds to the 2- to 10-fold, preferably the 2- to 5-fold, displacement path for which the second drive device is provided.

To ensure that the two mold parts remain reliably closed during the blow molding process, it is advantageous if the second drive device applies a closing force of over 200 kN, preferably over 500 kN, to the at least two mold parts in their closed position.

The invention will now be explained in detail by reference to an exemplary embodiment shown in the drawings, which, however, is not intended to limit the invention.

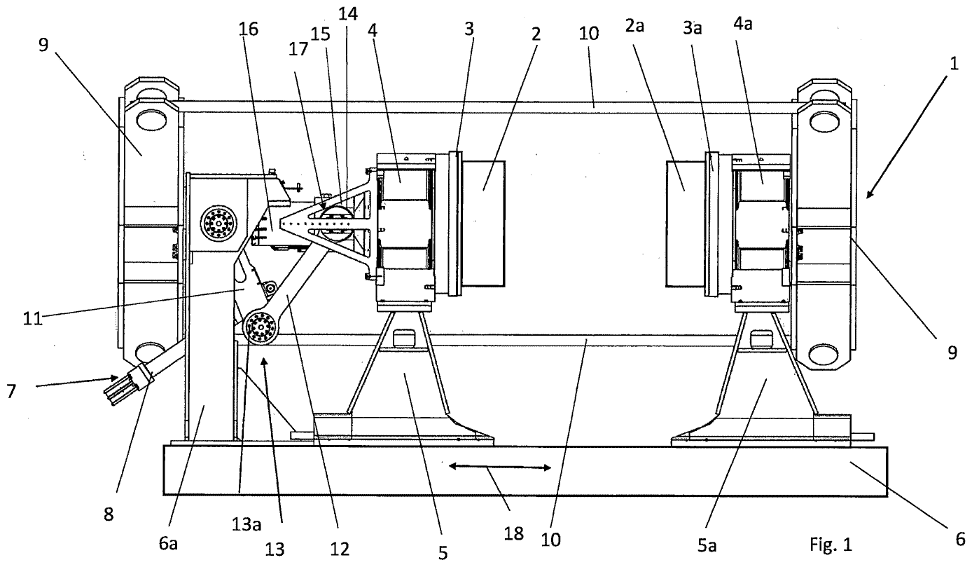

FIG. 1 shows a schematic side view of a device for producing hollow bodies from thermoplastic plastic material in a blow molding process in an open position.

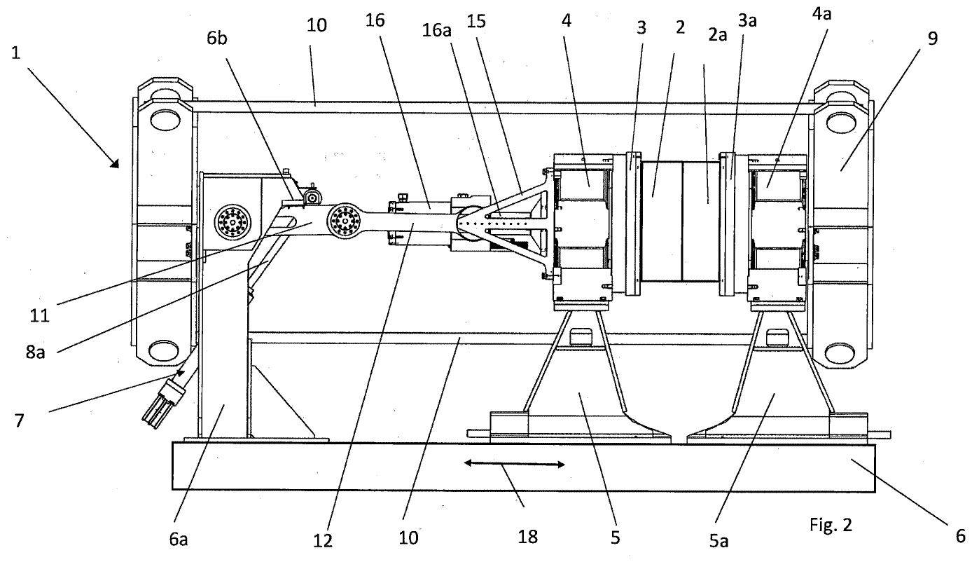

FIG. 2 shows a schematic side view of the device according to FIG. 1 in a closed position.

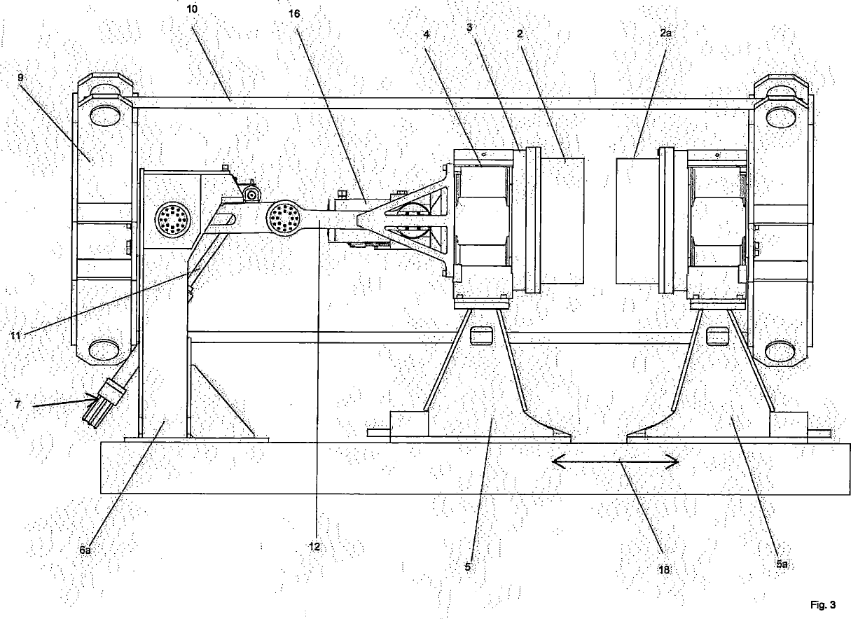

FIG. 3 shows a schematic intermediate position in which the piston of a second drive device is retracted.

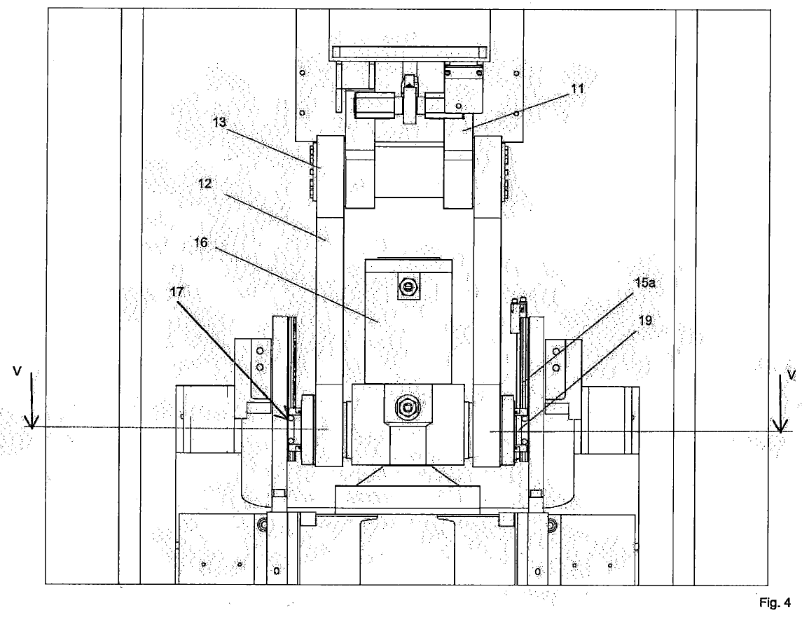

FIG. 4 shows a top view of the connection between a second drive device and a connecting element.

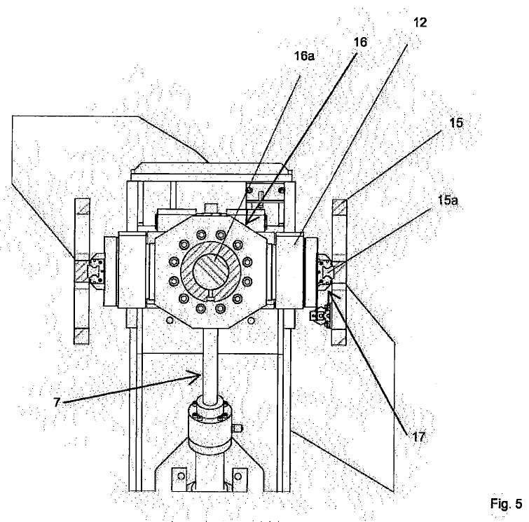

FIG. 5 shows a cross-sectional view along line V-V in FIG. 4.

FIG. 1 schematically shows a device 1 for producing hollow bodies from thermoplastic plastic material in a blow molding process, i.e. a so-called extrusion blow molding machine. In the position shown in FIG. 1, two mold parts or mold halves 2, 2a are in an open position. In this open position, both mold parts 2, 2a are arranged at a distance from each other so that, during operation of the machine, the two mold parts 2, 2a are moved into their open position, particularly to enable the lateral removal of a plastic container finished by the blow molding process. To easily transfer the two mold parts 2, 2a between a closed position as shown in FIG. 2, in which the two mold parts 2, 2a form a mold cavity in which the article to be produced is blown, and the open position shown in FIG. 1, both mold parts 2, 2a are displaceably mounted.

Each of the mold parts 2, 2a is attached to a closing plate 3, 3a, which in turn is each mounted on a force distributor 4, 4a. The force distributors 4, 4a are arranged on sliding mechanisms 5, 5a, which are configured in the form of carriages and are supported on a support device 6, specifically, a base plate, on the floor. The two sliding mechanisms 5, 5a are moved between open and closed positions, whereby two drive devices 7 and 16 indirectly act on sliding mechanism 5, and the sliding mechanism 5a is connected via a known synchronization device to sliding mechanism 5 so that the two mold parts 2, 2a are moved toward each other during a closing movement or moved apart during an opening movement when one of the drive devices 7 or 16 is actuated.

To transfer the mold part 2, mounted on sliding mechanism 5, from the open position shown in FIG. 1 to the closed position shown in FIG. 2, the mold part 2 is displaceably mounted and can be displaced via a first drive device 7 on the support device 6. More precisely, the first drive device 7, a cylinder 8, is mounted on a fixing element or post 6a arranged on the base plate 6. On the rear side, i.e. the side opposite the displaceable mold half, of the fixing element 6a, a bending beam 9 is attached, which is connected by tie rods 10 to another bending beam 9a located on the rear side of the force distributor 4a.

A piston 8a of the drive device is connected to a first lever element 11 of a toggle lever 13 that comprises two lever elements 11 and 12. The first lever element 11 is pivotably mounted on the fixing element 6a. The lever element 12 is pivotably connected on one side to the first lever element 11 via a rotary bearing 13a and, on the other side, is connected via an additional bearing 14 to a connecting element 15, which is attached to the force distributor 4.

The connecting element 15 is provided in particular for connecting a second drive device 16 to the force distributor 4 and is thus indirectly intended for the displaceably mounted mold half 2. A piston rod 16a of the hydraulic cylinder provided as the second drive device 16 is equipped with diametrically opposite guide bearings 17 for the connecting element 15, so as to avoid transmitting transverse forces to the hydraulic cylinder and thus to protect the seals of the second drive device 16.

To transfer the displaceably mounted mold parts 2 and 2a from the open position shown in FIG. 1 to the closed position shown in FIG. 2, the piston 8a is first extended to its full stroke; subsequently, the mold halves 2 and 2a are arranged in an intermediate position as shown in FIG. 3 in which they are closer together than in the open position. This transfers the toggle lever 13 into an essentially extended position and brings the two displaceably mounted mold parts 2 and 2a toward each other. In the illustrated embodiment, the toggle lever 13 is moved into a slightly overextended position so that the two lever elements enclose an angle of approximately 1. In this slightly overextended position, the lever element 11 abuts an upper stop 6b of the fixing element 6a so that the first drive device 7 does not have to actively hold the toggle lever in its slightly overextended position during the blow molding process.

After the sliding mechanisms 5 and 5a with the mold parts 2 and 2a have been displaced on the support device by activation of the first drive device 7 so that a major portion of the closing movement in the displacement direction 18 has been accomplished by a comparatively less powerful but fast drive device, i.e. a so-called rapid stroke has been executed) the second drive device 16 is activated to move the mold halves from the intermediate position shown in FIG. 3 to the closed position shown in FIG. 2. With this significantly more powerful drive device 16, a smaller displacement travel of the mold half 2, preferably about 200 mm to 400 mm, a so-called force stroke, is effected. Thus, the more powerful second drive device 16 generates a closing force of preferably over 500 kN between the two mold halves 2 and 2a.

In FIGS. 4 and 5 the connection between the second drive device 16 and a connecting element 15, which is connected to the force distributor 4 that carries the closing plate 3, is shown in detail.

In the connecting section between the cylinder provided as the second drive device 16, the so-called force stroke cylinder, and the lever element 12, guide bearings 17 are provided on opposite outer sides. Each guide bearing 17 preferably comprises a roller carriage 19 in which a guide rail 15a of the connecting element 15 is displaceably mounted. This guide rail serves to guide the cylinder provided as the second drive device 16. In this way, the transverse forces resulting from the closing movement of the toggle lever 13 are absorbed and transferred into the sliding element 5, so that the lever element 12 and the drive device 16 experience essentially no transverse loads or bending stresses, thus notably reducing wear on seals.

Through the two drive devices 7 and 16, which fulfill very different requirements, a fast and energy-efficient opening and closing of the two mold parts 2 and 2a is achieved. In the illustrated embodiment, the first drive device 7 is preferably configured as an electromechanical cylinder having a roller spindle with an electric drive. Alternatively, the electric drive may also be configured as a rotary drive with a gearbox and crank. It is also possible that a hydraulic cylinder is used as the first drive device 7, whereby in this case the hydraulic cylinder of the first drive device 7 has a significantly smaller diameter than the hydraulic cylinder provided as the second drive device 16.

1. Device for producing hollow bodies from thermoplastic plastic material in a blow molding process, comprising:
a cavity mold having at least two mold parts, wherein the mold parts are movable relative to each other;
a support device on which at least one mold part is displaceably mounted; and
a first drive device configured to displace the at least one mold part on the support device so that the two mold parts approach each other or move apart in a displacement direction; and,
a second drive device is configured to apply a closing force acting essentially in the displacement direction, wherein a toggle lever having a first and a second lever element, which are connected via a joint, is configured to displace the at least one mold part, and the second drive device is more powerful than the first drive device.

2. (canceled)

3. The device according to claim 1, wherein the first drive device is arranged on a fixing element that is rigidly connected to the support device and on a pivotably mounted first lever element of the toggle lever.

4. The device according to claim 1, wherein the first drive device or the second drive device is provided as a linear drive.

5. (canceled)

6. The device according to claim 3, wherein the second drive device is attached to the second lever element.

7. The device according to claim 1, wherein the at least one displaceably mounted mold part and the second drive device are mounted on a sliding element which is displaceably supported on the support device.

8. The device according to claim 7, wherein a hydraulic cylinder provided as the second drive device and/or the piston rod of the hydraulic cylinder comprises guide bearings, arranged diametrically on opposite sides, for a connecting element between the hydraulic cylinder and/or the piston rod and the sliding element.

9. The device according to claim 1, wherein in a closed position of the at least two mold parts, the toggle lever is arranged in a slightly overextended position.

10. The device according to claim 9, wherein a stop is provided at which the toggle lever abuts in the closed position of the at least two mold parts.

11. The device according to claim 1, wherein the second drive device is configured to displace the at least one mold half by up to 700 mm.

The device according to claim 1, wherein the first drive device is configured to displace the at least one mold part between 0.7 m and 2 m.

13. The device according to claim 1, wherein the first drive device is configured to perform a displacement path of the at least one mold half that essentially corresponds to the 2- to 10-fold displacement path for the execution of which the second drive device is configured.

14. The device according to claim 1, wherein the second drive device applies a closing force of over 200 kN, to the at least two mold parts in their closed position.

15. The device according to claim 1, wherein:
the first drive device is provided as a first hydraulic cylinder or an electric drive with a first piston rod, or as a rotary drive; or
the second drive device is provided as a second hydraulic cylinder with a second piston rod.

16. The device according to claim 3, wherein the second drive device is attached to the second lever element at a free protruding end of the second lever element.

17. The device according to claim 1, wherein the two lever elements in the overextended position enclose an angle between 0.5° and 3°.

18. The device according to claim 9, wherein a stop is provided at which the first lever element abuts in the closed position of the at least two mold parts.

19. The device according to claim 1, wherein the first drive device is configured to perform a displacement path of the at least one mold half that essentially corresponds to the 2- to 5-fold displacement path for the execution of which the second drive device is configured.

20. The device according to claim 1, wherein the second drive device is configured to displace the at least one mold half by up to 500 mm.

21. The device according to claim 1, wherein the second drive device is configured to displace the at least one mold half by between 200 and 400 mm.

22. The device according to claim 1, wherein the second drive device applies a closing force of over 500 kN to the at least two mold parts in their closed position.
